(19) United States
(12) Patent Application Publication
(10) Pub. No.: US 2012/0068465 A1
(43) Pub. Date: Mar. 22, 2012

(54) Vertical axis wind turbine generator with sails

(76) Inventors: Freddy Dawoud, W. Covina, CA (US); Annetta Yacoub, W. Covina, CA (US)

(21) Appl. No.: 12/807,915

(22) Filed: Sep. 17, 2010

(51) Int. Cl. F03D 9/00

(52) U.S. Cl. 290/55

(57) ABSTRACT

Wind energy converter that uses a metal ring rotating around on a vertically anchored mast. Sails are raised and lowered in sequence by wires to catch wind and rotate ring. A 150 m height vertical axis sail system as describe will generate 500 kw in 10 m/s wind velocity.

### REFERENCES

Feldman—U.S. Pat. No. 5,171,127—1992.
Green—0263057 A1—2005
O'Dell—U.S. Pat. No. 5,454,694—1995.

### BACKGROUND OF THE INVENTION

The bottom line that determines the ultimate success of any wind turbine system is the ratio of (US$ cost of installation/kwh produced)

With the current climate change crisis and energy demand rising, the world is looking for wind power to provide a bigger share of the energy demand. Wind energy is widely available but is a dilute form of energy. Turbine blades have to be large to catch enough kinetic energy from the low density air medium. Energy production is also an economic investment; the bottom line for the success of any wind turbine design, is the cost to power produced ratio ($/kwh).

The majority of Wind power generators are now of the horizontal axis three bladed turbine design pioneered by Denmark in the seventies. It is manufactured by handful of manufacturers, who are able to produce the huge sized, heavy weight, and highly accurate components like the blades, slew rings, generators, towers, and control systems for such large machines. These systems have achieved better economics by time, but the power generated is till higher in cost than from power plants using coal, oil, and natural gas, and can only be manufactured by a limited number of manufacturers.

It is the object of this patent to introduce a wind turbine that give a better cost to power ratio ($/kwh) than all the presently available WTG's (Wind turbine generators) by a wide margin. This is achieved through a design that is lighter in weight, uses less expensive materials, easier to manufacture, and at the same time has more mechanical efficiency through the capture of wind energy through pure drag, rather than as angular component as in the propeller types, by using time proven technology which is the simple sail.

The new invention gives several major advantages on the previous horizontal axis technology:

### Advantages:

Uses pure Drag.
No large dies, no readily unavailable materials
Extremely low weight/kw produced ratio compared to traditional WTG's.
No noise/no bird strikes.
Can be used offshore.
More height→300 m if you like or more.
Generators at ground height.
Easy maintenance and quick change of moving parts.
Small foot print.
Can be used for advertisement near beaches or populated areas.
No high crane is required for installation. Uses telescopic mast to raise the mast.
No gear boxes are used/no oil spills.

A number of sail wind energy systems were invented but commercial utilization has not been reached due to impracticalities:

Feldman et al—U.S. Pat. No. 5,171,127, 1992.
uses a generator which is connected to the shaft of the vertical axis turbine, and uses centrifugal force to open and deploy the sails. The centrifugal force requires high speed operation, which is detrimental to the efficiency of the device. Our system uses extremely low rotational speed, which has a much higher efficiency.
   Green—patent no. 0263057 A1, 2005
Uses four different sails located on the edges of four beams rotating on a column, and the sails are furled to vary the resistance of the wind causing the device to rotate. Device is cumbersome, and will have a high structural weight in comparison to the output. Our device is more simpler, and more structurally efficient, thus cheaper.
   O'Dell—U.S. Pat. No. 5,454,694—1995.
Uses a furling mechanism composed of four masts at edges of turbine. Furling mechanism is structurally heavy. Our device is more structurally efficient, and thus will produce power more cheaply.

We proposed a system which has two major advantages over all of the above the mentioned inventions, thus over coming the two major obstacles to practical utilization of vertical axis sail systems; the wind force is captured in a more efficient structural system, and the deployment system of the sails are much more simpler.

### BRIEF DESCRIPTION OF THE SEVERAL VIEWS OF THE DRAWING

FIG. 1 Isometric view showing onshore turbine, one sail is deployed, another is about to be raised, and the two other sails are retracted. The open sail catch the wind and rotates arms (6), thus rotating ring (5), and causing generators (20) to rotate producing electricity. The mast is fixed vertically by guy wires (4) to ground, and the sails are raised and lowered at the correct timing to keep ring rotating in the same direction. Additional wheels anchored to ground (30,31), may be used to give additional stability to ring (5) while still allowing it to rotate.

FIG. 1A. Rendered view of onshore turbine, which has a height of 150 meters, showing a typical automobile below it.

FIG. 2. Exploded view of turbine showing the major components; the mast (1), the ring, four sails, the bearings (3), and the generators (20)

FIG. 3. Showing the method of raising and retracting the sails. A wire (44) is used to pull the sail (8) upward. It is pulled by a motor (43) at the bottom. A counter weight (42) is used to reduce the tension required to raise sail.

FIG. 4. Isometric view showing another version of the invention used for offshore application. The shot shows the typical scale recommended for offshore with a mast height of 150 meter. A typical container ship is shown along side to show scale of the invention.

FIG. 5. Isometric view of offshore version, showing one sail deployed, and one sail partially raised and about to be deployed to catch wind.

FIG. 6. Aerial view of offshore version, showing the direction of the wind with respect to the opening and closing timing of the sails.

FIG. 7 Exploded view of offshore version showing the different components. The pontoons (61) are floated on the sea, and support the fixed beams (60), which has guy wires connected to top of mast bearing (3). The pontoons are anchored to sea floor with chains (70). The lower mast bearing (3) is supported on said pontoons. The mast (1) is located with that bearing, and the top bearing. The top bearing is fixed in place by having four wires (4) in tension, which are connected to the pontoons. The ring is supported on its edge the internal sail wires (7), which also functions as a guide for raising and lowering sail (8).

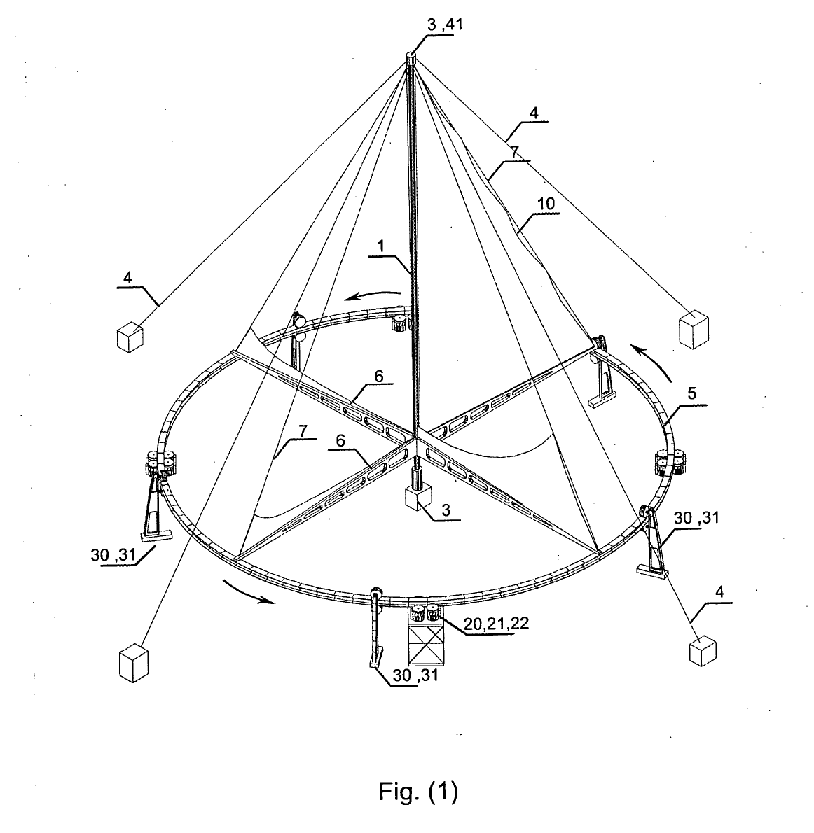

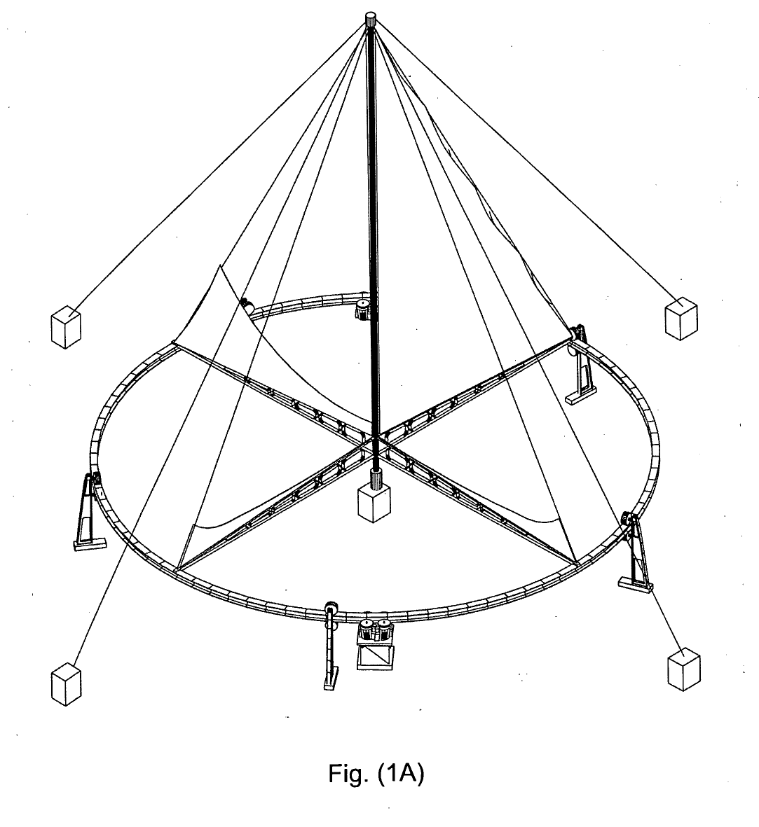

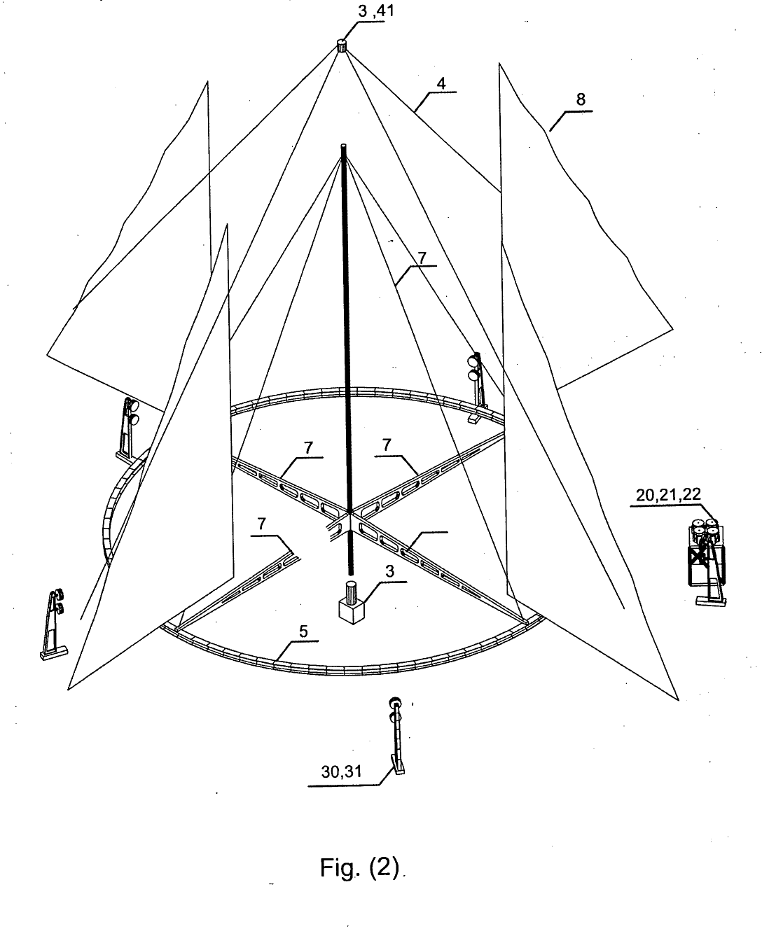

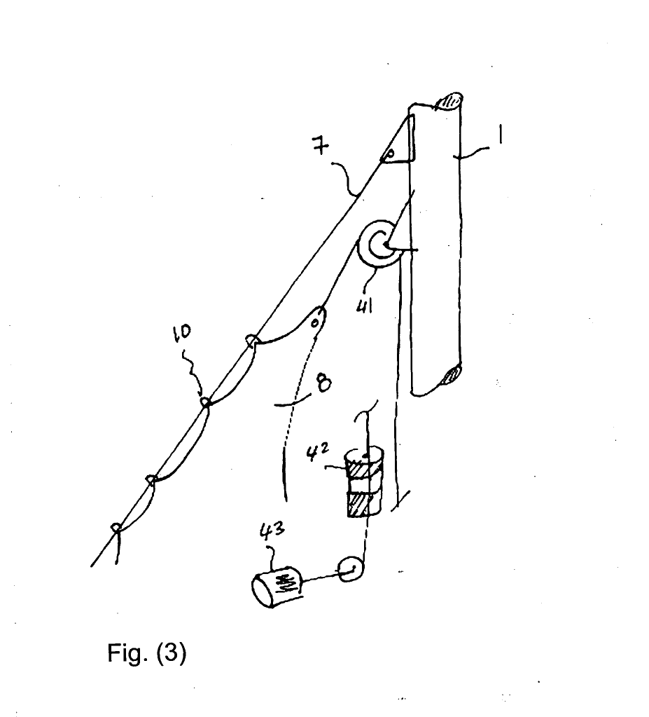

FIG. (8). Close up isometric view showing the location of the generators (20) which are fixed to pontoon beams (60), and are in contact with the ring (5). When ring rotates, the generators are rotated, and produce electricity.

### DETAILED DESCRIPTION OF THE INVENTION WITH EXPLANATION TO THE DRAWINGS

### Construction:

One vertical mast (1) has a antifriction bearing (3) at both ends. One end is fixed to bearing which is fixed to the ground. The guy wires (4) are tied to the top mast bearing (3), and are tied to the ground foundations in three or more directions. This allows the mast to rotate while staying vertical without leaning to one side. This vertical mast may be constructed of concrete, wood, or steel tube. The mast is tied to wires to avoid buckling in two or more points along its height.

One very large diameter steel or wood power take off ring (5) is fixed to lower part of mast (1) about 4 meters above ground, thus allowing agricultural and use of land underneath. Large lattice or built up steel beams (6) connect ring to mast. Ring may also be connected to mast at a few more points with wires (7). Wire supports ring and prevents mast from buckling.

Rotating ring is connected rotationally to mast with sail cross beam (6) Cross beams rotates around mast by an antifriction bearing.

A large area fabric sail, preferably embedded with light steel wires is suspended from a wire to the top of the mast. The sail is connected to the wire (7) with small low friction hangers, which may be have wheels to facilitate the sliding of the sail edge to the wire. The bottom edge of the sail is fixed to the sail cross beam. Each cross beam has its own sail. 4 or more sails are used symmetrically around mast (1).

Power generators (20) are installed so that there take off wheels or gears are in contact with the ring, and thus are rotated by the ring; when ring rotates, the generators produce electricity. The power generators are fixed to ground with a steel structure (31) to support ring.

### Operation:

Sails are raised in down wind section of the rotation, and lowered in the upwind section. Thus causing the ring to rotate, and the generators to produce electricity.

### Sail Raise and Lower:

Sail raise wire (40) is hanged on a pulley 941) on top of mast. A counter weight (42) is used at bottom of wire to reduce the force required to deploy sail. A small electric winch raises or lowers sail.

If the two sails are installed at 180 degrees opposite to each other. One winch may be used for two sails simultaneously.

The counter weight (42) at the bottom of wire may be used to limit the power drawn by the winch motor to overcome the friction only.

A wind direction sensor activates the winches and the sails at the correct timing to keep the sails down in upwind zone, and vise versa.

### In Extreme Weather:

Sensor activates winch to lower all sails.

### Rotational Speed Control:

Under no load, the speed of the tip of the sail is almost the same as the wind speed, but will generate no power.

The trick is to choose or balance the resistance (Torque) of the generators to be equal to that of the ring so that the average sail speed at the middle is about 3 m/s in a wind speed of about 10 m/s, which is about 75% slower than the wind speed, to produce the most power. This may be with a number ways; one of which is install a number of small generators in contact with the ring, and control the number of generators that are energized. The higher the wind speed, the more the number of generators on line and vice versa.

Maximum linear ring speed is dictated by the wind speed, but should be lower significantly. The tip speed may be about 5 m/s, which for a 150 m diameter ring, would translate to a rotational speed of 0.8 rpm. If the generator pulley or gear is 15 cms in diameter, this will give a generator rotational speed of about 530 rpm, which means that we do not need a gearbox, which is a very big saving in cost, and a great boost to reliability.

### Onshore Installation Sequence:

No high crane is required for installation of the wind energy converter. The mast foundation, and the guy wire foundations are laid in the ground. The mast is laid down horizontally, and anchored pivotally to its ground foundation, another medium height temporary mast is used to raise the mast, while it is anchored to the ground, and to keep it from tipping side ways. A winch is used to raise the mast, and all the guy wires are tensioned. The ring sections and the sail horizontal beam are connected to the mast. The wires carrying the outer edge of the sail are connected to the power take off ring, and tensioned. The generators are installed on their platforms, which are fixed to the ground. The generator wheels are put in contact with power takeoff wheel. The sails are installed and the deployment wires, and winches are installed. The sails are raised, and the device is energized.

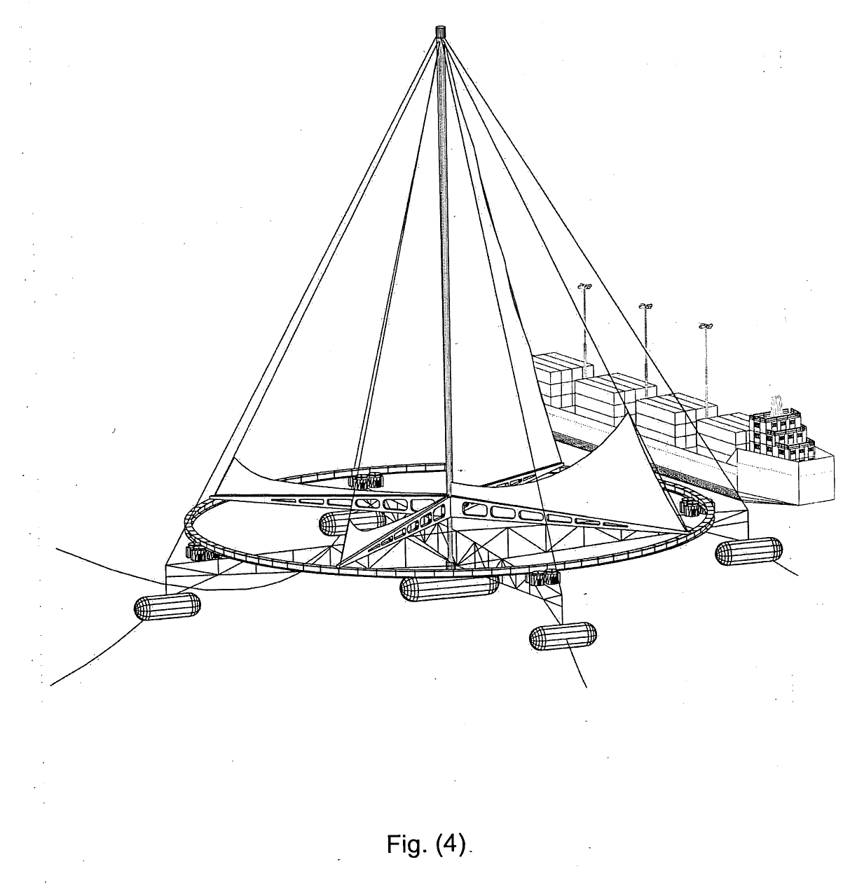

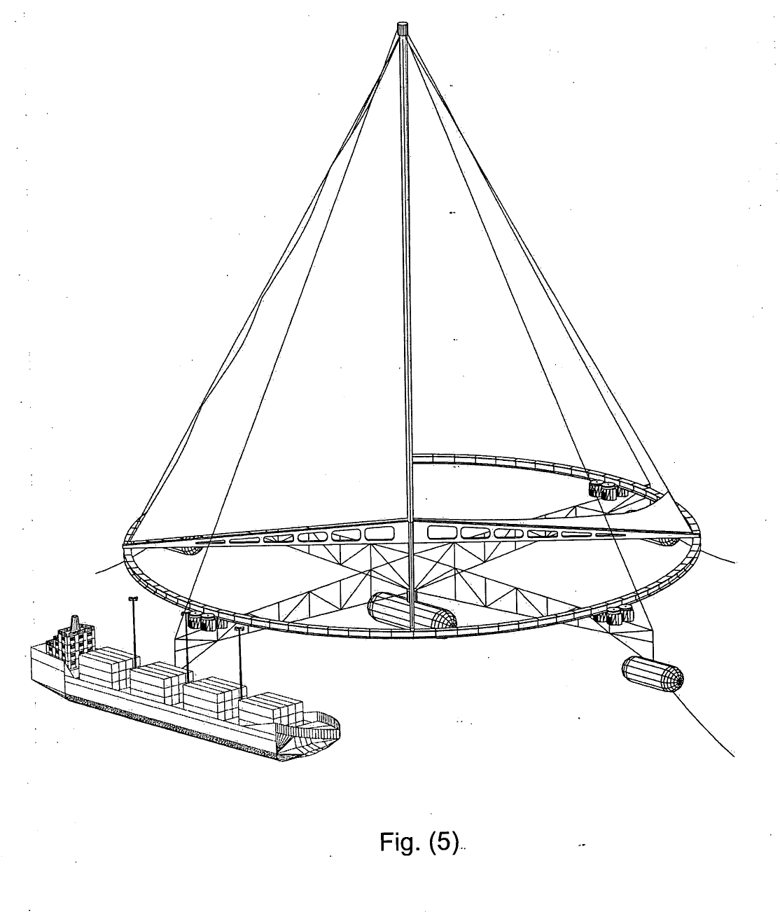

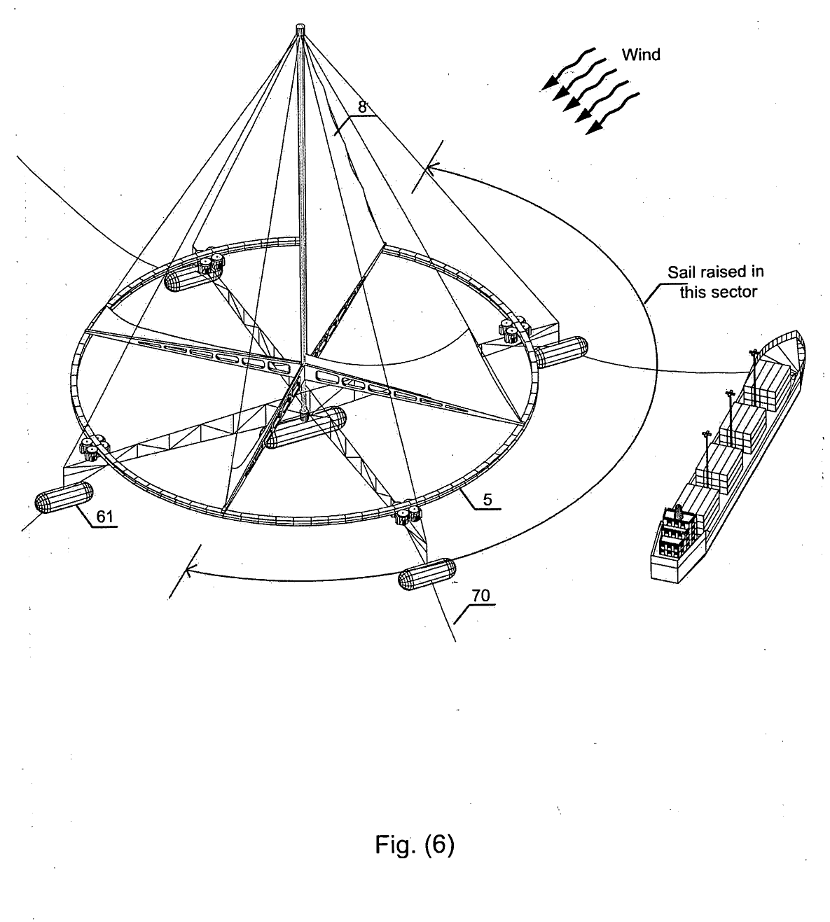

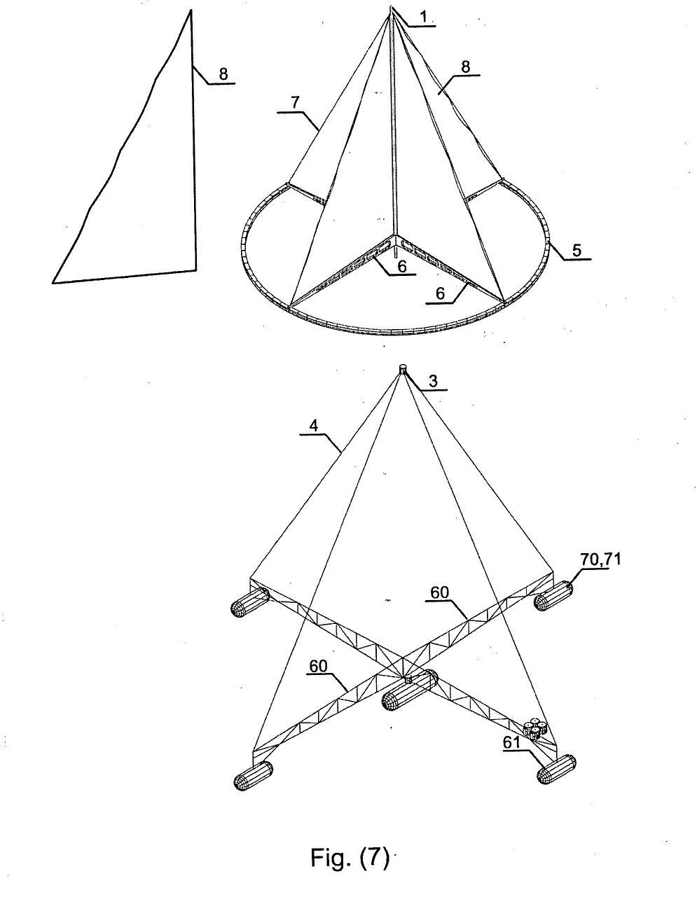

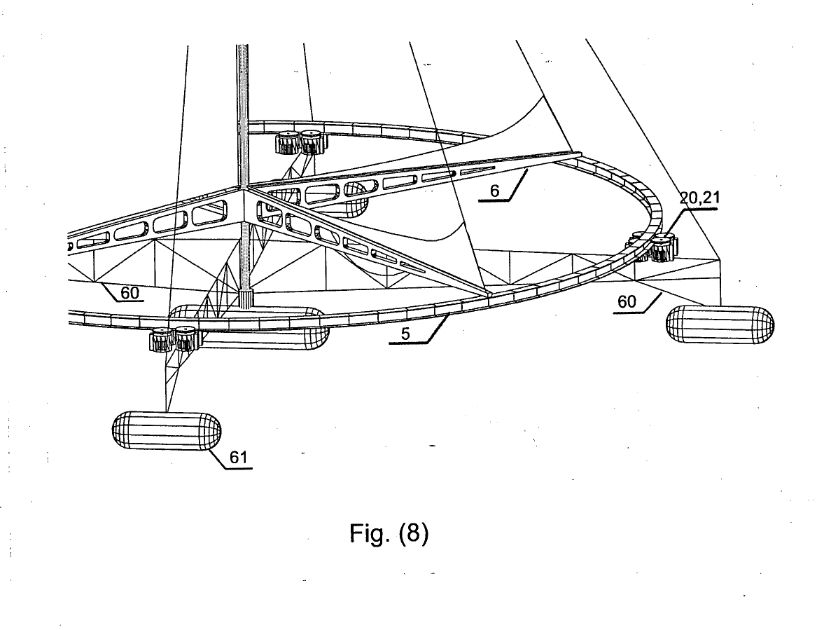

### Offshore Version: (FIGS. 4,5,6)

It is very important to be able to generate power from wind out in the ocean. The wind is much more powerful and steadier, and the areas available are practically unlimited, with less interference from the population areas.

Another version of this device is designed for offshore installation. FIG. 4) shows this device. The vertical mast (1) is installed on three or more horizontal beams preferably, a lattice structure beams (60). The tips of the beams are connected to pontoons (61) at the end. Another pontoon is installed in the center. The generators (20) are installed on the pontoons or the floating beams, and thus are in contact with the ring. The vertical mast is tethered by the pontoons by guy wires (4) to keep the vertical mast from leaning to any side. Each pontoon may be anchored to the sea floor with chains (70). Power cables (71) are deployed on sea floor to transmit power to shore.

### Offshore Installation Sequence:

For offshore installation. It is preferable to use a telescopic vertical mast. The pontoons are floated into the water in a port using the existing port cranes. The horizontal beams connecting the pontoons are installed. The vertical telescopic mast is installed on the center pontoon. The power take off ring is installed with its beams to the mast. The telescopic mast is raised stage by stage. After each stage, the guy wires are tightened to the ring, while the ring is temporarily fixed to the pontoons to avoid tipping. After the last telescoping stage is raised, the top of the mast is fixed to the pontoons with the guy wires. The sails are installed with their deployment wires, and winches. The ring is allowed to rotate. The whole device is towed out to its location with a barge, and anchored to the sea floor, with power cable delivering electricity to the on shore connection point.

### Typical System Scale:

The vertical mast may be selected to have a height of 150 m with a power take off ring diameter of 150 m.

The sail area is 75×150×0.5=5600 m2
Average sail speed is selected to be=3 m/s
Wind speed=10 m/s
Drag force on sail=0.5 Cd Ro A V̂2=165000 N

### Power=Fd×V=1155 Kw=1 MW

### Weight of Material Used:

Vertical mast=steel tube weight=60 tons
Ring beams=steel lattice structure=4×5.2 tons=21 tons approx.
Ring=Steel ring 10 tons
Generators support structure=5 tons
Variety of guy wires=Approx. 2000 meters of 16 mm wires.
Sails=Four sails each of 5600 m2

### Total Material Used:

140 tons of steel
1000 m of wires of 20 mm dia
20000 m2 of fabric sails
8 generators, 125 kw each.
4 sail hoist motors, 2.2 kw each.

I claim:

1. A wind energy converter comprises:
A vertical compression bearing element called ‘Mast’, which is fixed to ground. The top of mast is connected to two or more tension bearing elements fixed to ground at a distance from the mast fixation point.
One large diameter compression bearing object called ‘ring’ Said ring is connected to one or more low friction bearings that is installed on lower part of mast called ‘sail bearing’. Said ring is connected to said ‘sail bearing.’ with three or more compression or tension bearing elements called ‘sail beams’.
Said ring rotates around the longitudinal axis of said ‘mast’.
One or more antifriction bearings are installed on upper part of mast called ‘upper bearing’ below fixation point of said guy wires. The outer edges of ring are connected to said upper bearing with tension bearing element called ‘sail edge wire’.
A flexible membrane element called ‘sail’ which is anchored to points at said ‘sail beam’. Said sail beam has wheels or low friction rings attached to outer edge of sail which can slide up and down said sail stays.
Tension bearing flexible element called ‘sail raise wire’ which pulls upper edge of sail to the top of the mast to deploy said sail.’
Sail raise wire is pulled or released by an activation mechanism according to position of sail beam relative to wind direction causing the sail to raised in down wind direction, and retracted in upwind direction.
Bend resistant element called generators beam which is fixed to mast below sail bearings.
Said generator beam may also be anchored to ground in such a way to prevent rotation relative to ground.
One or more electrical generators, hydraulic pumps, or friction heat generators, called power generators are fixed to sail generator beams near the said ring.
Said power generators are in contact with said ring by positive contact or gears or frictional contact such that when said ring rotates movement is transferred to said power generators.
Wind energy converter comprising a Controller which depending on wind direction, selectively raises and lowers sails such that sails are raised in one 180 degrees zone, and lowered in the opposite zone, thus causing ring to rotate in one direction causing generators to produce power.
In a preferred embodiment, the generators beam may be anchored to ground with wires or structural elements.
In a preferred embodiment, for use of this device on a water body:
Said sail mast is installed on one or more floating objects. Two or more buoyant objects are use to stabilize said mast at a distance from the bottom end of said mast, and to prevent it from tipping.
The buoyant object under mast as well as under generators form together a floating platform. Said floating platform is composed of two or more of said floating objects. Said floating platform may be anchored to sea or lake floor using one or more wires or chains.
Said ‘mast’ ring power generators are installed on three or more buoyant object called floating platform. Said floating platform is anchored to sea floor by one or more wires.
